(19) United States
(12) Patent Application Publication
(10) Pub. No.: US 2016/0192443 A1
(43) Pub. Date: Jun. 30, 2016

(54) SUPPORT STRUCTURE FOR ELECTRIC CABLES OF A SURFACE HEATER

(71) Applicant: Schluter Systems, L.P., Plattsburgh, NY (US)

(72) Inventor: Werner Schluter, Iserlohn (GE)

(21) Appl. No.: 14/868,080

(22) Filed: Sep. 28, 2015

(30) Foreign Application Priority Data
Oct. 7, 2014 (GE) 2020141047952.1

(51) Int. Cl. H05B 3/06; H02G 9/02

(52) U.S. Cl. CPC H05B 3/06; H02G 9/02

(57) ABSTRACT

A support structure for electric heating cables of a surface heater includes a film-like support layer with projections that extend upward and that define heating cable receiving channels therebetween for receiving the electric heating cables. A thermal barrier layer is fastened to the bottom side of the support layer.

### PRIORITY CLAIM

Priority is claimed of and to German utility model application number 20 2014 104 792.1, filed Oct. 7, 2014, which is hereby incorporated herein by reference in its entirety.

### FIELD OF THE INVENTION

The present invention relates to support structures for facilitating the arrangement of electric heating cables.

### BACKGROUND OF THE INVENTION

Support structures for facilitating the arranging of electric heating cables are already known in the prior art. Their purpose is to facilitate the arranging of electric heating cables of a surface heater. In contrast to conventional surface heaters that use water as a heating fluid, electric surface heaters have the advantage that they are of significantly smaller height, which is why they are particularly suitable for retrofitted installation, for example during renovations, to name only one example. Another advantage of electric surface heaters is that they have much shorter heat-up times compared to conventional surface heating means, such that they can produce a detectable effect in a very short time after they are turned on. With this in mind, it is not uncommon for an electric surface heater to be installed in addition to a conventional surface heater in order to react quickly to variable temperatures, particularly in the spring and fall, without having to turn on the primary heater.

### SUMMARY OF THE INVENTION

The present invention provides improvements to existing electric surface heating systems, in particular with regard to even shorter heat-up times.

Toward this end, the present invention provides a support structure of the type mentioned above, the structure characterized in that a thermal barrier layer is attached to the bottom of the support layer. The advantage of the thermal barrier layer according to the invention is that the great majority of the thermal energy given off by an electric heating cable held in the heating cable receiving channels during the heat-up period of an electric surface heater is dissipated toward the top of the support structure. This allows the heat-up time of an electric surface heater to be greatly reduced thanks to the thermal barrier layer. Investigations in this regard have shown that the heat-up phase can be shortened by up to 40%. On the other hand, the thermal barrier layer according to the invention has almost no affect on the long-term operation of an electric surface heater. As soon as the heat given off by the heating cables has penetrated the thermal barrier layer, equilibrium sets in such that heat is dissipated evenly in both directions; that is to say toward the room and toward the lower base. The thermal barrier layer can be glued to the bottom of the support layer using a suitable adhesive. Alternatively, it can also be laminated or otherwise attached.

According to one embodiment of the present invention, the thermal barrier layer has a height in the range of 1 to 3 mm, in particular in the range of 1.5 to 2.5 mm. Investigations have shown that thermal barrier layers with a height of less than 1 mm do not achieve any significant shortening of the heat-up time. Heights of more than 3 mm only result in minor improvement of the heat-up times. Moreover, 3 mm should not be exceeded since otherwise the height of the support structure will be too much overall, which is not desirable, particularly when used in renovation work.

In one embodiment, the thermal barrier layer is made of a foam material or a fleece material.

It is advantageous that an adhesion promoting layer is provided at the bottom side of the support structure. An adhesive or mortar used to fasten the support structure to a lower base clings to such an adhesion promoting layer. This ensures a secure attachment of the support structure during installation. The adhesion promoting layer can be fastened to the thermal barrier layer as a separate layer. For example, it can be glued to the thermal barrier layer. Alternatively, the thermal barrier layer and the adhesion promoting layer can be designed as a single piece. For example, the bottom of a thermal barrier layer made of fleece material can also simultaneously be used as an adhesion promoting layer.

It is advantageous to design the thermal barrier layer as being stable against pressure. As such, outside loads can be easily transferred to the lower base.

The edge areas of the protrusions can have indentations as viewed from above, the indentations defining part of the heating cable receiving channels. Such indentations facilitate the attachment of the electric heating cables to the support structure.

It is advantageous that the distances between the protrusions are narrow relative to the outer diameter of the heating cables to be held in place such that the heating cables can be pressed into the heating cable receiving channels in between two adjacent protrusions from above in the manner of a snap-on connection, which widens said distance. In other words, the heating cables in such an embodiment of the support layer can be simply clipped into the heating cable receiving channels, providing an automatic means of attachment.

It is advantageous that depressions are formed inside the protrusions, the base of said depressions being disposed at the height of the bottom side of the support layer. Such depressions inside the protrusions can improve the load transfer to the bottom of the support structure.

The support structure can be a rollable mat. Rollable mats have the advantage over conventional plates in that they can be transported more easily and laid out more quickly.

There has thus been outlined, rather broadly, relatively important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a partially sectioned perspective view of a support structure according to one embodiment of the present invention; and

FIG. 2 is a sectional view of the support structure of FIG. 1, as shown in the installed state.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to a “cable” can include one or more of such “cables.”

Definitions

In describing and claiming the present invention, the following terminology will be used in accordance with the definitions set forth below.

As used herein, the terms “upper,” “lower,” “elevation,” “height,” and the like, are to be understood to refer to relative locations and/or displacements of various elements or components relative to a condition in which a veneer system is oriented in its usable orientation. These terms are used to more clearly claim and describe the various elements or components of the invention and, unless the context clearly indicates otherwise, are not to be construed as limiting the invention to any particular embodiment.

As used herein, the term “substantially” refers to the complete or nearly complete extent or degree of an action, characteristic, property, state, structure, item, or result. As an arbitrary example, an object that is “substantially” enclosed is an object that is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As an arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Invention

The figures show a support structure 1 according to an embodiment of the present invention for electric heating cables 2 of a surface heater, such as a floor or wall heater. The support structure 1 is in the form of a rollable mat and comprises a film-like support layer 3 on the top side, the layer being made of polypropylene in this case, wherein other plastics can be used as well. The support layer 3 comprises a plurality of upward-pointing protrusions 4 distributed over the surface thereof, the protrusions forming heating cable receiving channels 5 therebetween for holding the electric heating cables 2. The edge areas of the protrusions 4 comprise indentations as observed from above, the indentations defining part of the heating cable receiving channels 5. The distances between the protrusions 4 are selected to be narrow relative to the outer diameter of the heating cables 2 being held in place in such a way that heating cables 2 located between two adjacent protrusions 4 can be pushed from above into the heating cable receiving channels 5 in the manner of a snap-on connection, causing the distances to expand so that the heating cables 2 can be held securely in the corresponding heating cable receiving channels 5. Depressions 6 are made inside the protrusions 4, the base 7 of the depressions being disposed at the height of the bottom of the support layer 3. A pressure-stable thermal barrier layer 8 is fastened to the bottom of the support layer 3, the layer being made of a fleece material in this case, with a height in the range of 1.5 to 2.5 mm. Alternatively, the height can also be selected within a range of 1 to 3 mm. According to another embodiment of the support structure 1 according to the invention, the thermal barrier layer 8 can also be made of a foamed material and provided with a fleece or fabric at the bottom thereof, although this in not shown in the present case.

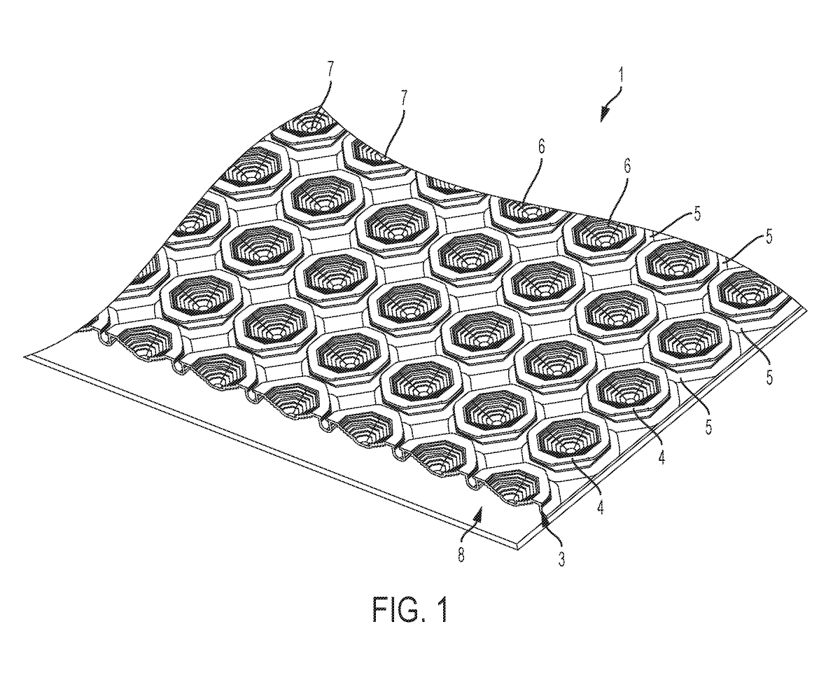

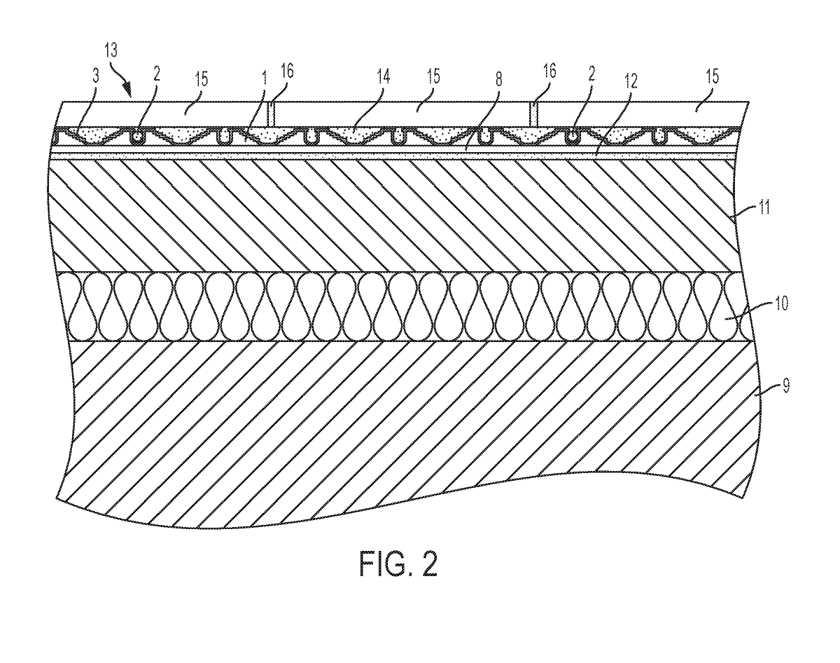

FIG. 2 shows a possible design using the support structure 1 shown in FIG. 1. The design comprises a supporting lower base 9 as a lowermost layer, the layer possibly being a concrete floor, for example. Positioned on the lower base 9 is a conventional insulating layer 10, consisting of individual insulating plates. The insulating plates can be placed loosely onto the lower base 9 as is presently the case. However, they can also be fixed to the lower base 9 using a mortar or adhesive. Instead of insulating plates, poured insulation can also be used to form the insulating layer 10. Above the insulating layer 10 is a screed layer 11 for gluing the bottom of the support structure 1. The adhesive 12 used here can be a tile cement or the like, for example. Due to the fact that the thermal barrier layer 8 is made of a fleece material, the adhesive clings well to the thermal barrier layer 8 as the support structure 1 is being glued into place, resulting in a secure hold. The same applies when the bottom of the support structure 1 is made up of the fleece adhesion promoting layer mentioned above or of a fabric. One or more heating cables 2 are held at the top of the support structure 1 in some of the heating cable receiving channels 5 provided for the same. Above the support structure 1 is a floor covering 13 that is glued to the top of the support structure 1 using a suitable adhesive 14 which reaches into the indentations provided at the protrusions 4. The adhesive 14 can be a tile cement, to name just one example. In this case, the floor covering is formed by panel elements 15, which can be tiles, stone plates or the like, wherein the joints 16 present between the panel elements 15 are filled with a suitable joint material. Alternatively, however, a wood floor can also be installed as a floor covering.

A significant advantage associated with the use of the support structure 1 according to the invention is that thanks to the thermal barrier layer 8, the great majority of the thermal energy given off from the electric heating cables as the surface heater is starting up is dissipated toward the top of the support structure 1 and thereby in the direction of the room. This allows the heat-up time of an electric surface heater to be greatly reduced thanks to the thermal barrier layer 8. Investigations have shown that in this way, improvements of up to 40% can be achieved. Because of the small thickness of the thermal barrier layer 8, a relatively low total design height of the support structure 1 is maintained despite this fact, such that the structure can also be installed onto previously existing screeds as part of renovation or restoration work. The film material of the support layer 3 and the material selected for the thermal barrier layer 8 provide the support structure 1 overall with an elasticity that acts to decouple the screed layer 11 and the floor covering 13 and prevents the transfer of stresses caused by different expansions of the screed layer 11 and the floor covering 13 because of different coefficients of thermal expansion, for example. The large surface area taken up by the cable receiving channels 5 and the respective base 7 of the depressions 6 relative to the overall surface area of the support structure provides good load transfer for the screed layer 11, which results in a very durable arrangement.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

### LIST OF PARTS

1 Support structure
2 Heating cable
3 Support layer
4 Protrusion
5 Heating cable receiving channel
6 Depression
7 Base
8 Thermal barrier layer
9 Lower base
10 Insulating layer
11 Screed layer
12 Adhesive
13 Floor covering
14 Adhesive
15 Panel element
16 Joint

What is claimed is:

1. A support structure for electric heating cables of a surface heater, comprising:
a film-like support layer with projections that extend upward and that define heating cable receiving channels therebetween for receiving the electric heating cables; and
a thermal barrier layer fastened to a bottom side of the support layer.

2. The support structure according to claim 1, wherein the thermal barrier layer has a height in the range of 1 to 3 mm, in particular in the range of 1.5 to 2.5 mm.

3. The support structure according to claim 1, wherein the thermal barrier layer is made of a foam material or a fleece material.

4. The support structure according to claim 1, further comprising an adhesion promoting layer provided at the bottom side of the support structure.

5. The support structure according to claim 1, wherein the thermal barrier layer is designed to be stable against pressure.

6. The support structure according to claim 1, wherein edge areas of the protrusions have indentations as viewed from above, the indentations defining part of the heating cable receiving channels.

7. The support structure according to claim 6, wherein distances between the protrusions are narrow relative to the outer diameter of the heating cables to be held in place such that the heating cables can be pressed into the heating cable receiving channels in between two adjacent protrusions from above in the manner of a snap-on connection, which widens said distance.

8. The support structure according to claim 1, further comprising depressions formed inside the protrusions, a base of said depressions being disposed at a height of the bottom side of the support layer.

9. The support structure according to claim 1, wherein the support structure is a rollable mat.
